(19) United States
(12) Patent Application Publication
(10) Pub. No.: US 2025/0018342 A1
(43) Pub. Date: Jan. 16, 2025

(54) PRODUCTION METHOD AND PRODUCTION DEVICE FOR ION LIQUIDS OR ION LIQUID RAW MATERIALS

(71) Applicant: National University Corporation Kumamoto University, Kumamoto-shi, Kumamoto (JP)

(72) Inventors: Shin-ichi OHIRA, Kumamoto-shi, Kumamoto (JP); Kei TODA, Kumamoto-shi, Kumamoto (JP); Md. Aminul HAQUE, Kumamoto-shi, Kumamoto (JP)

(21) Appl. No.: 18/710,102

(22) PCT Filed: Oct. 31, 2022
(86) PCT No.: PCT/JP2022/040795

§ 371 Date: May 14, 2024

(30) Foreign Application Priority Data
Nov. 16, 2021 (JP) 2021-186459

(51) Int. Cl. B01D 61/42; C25B 9/21; C25B 15/08

(52) U.S. Cl. CPC B01D 61/42; C25B 9/21; C25B 15/08

(57) ABSTRACT

A device for producing an ionic liquid or an ionic liquid raw material includes a reactor having a first space that is in contact with an anodic electrode part and a first ion exchange membrane part and that accommodates a first liquid, a second space that is in contact with the first ion exchange membrane part and a second ion exchange membrane part and that accommodates a second liquid, and a third space that is in contact with the second ion exchange membrane part and a cathodic electrode part and that accommodates a third liquid, the first space, the second space, and the third space being stacked in the order presented, wherein the ion exchange membrane parts both use a positive ion exchange membrane or a negative ion exchange membrane.

### TECHNICAL FIELD

The present invention relates to a method for producing an ionic liquid or an ionic liquid raw material. The present invention also relates to a device for producing an ionic liquid or an ionic liquid raw material.

### BACKGROUND ART

“Ionic liquids”, which are composed of a combination of positive ions and negative ions and are liquid even at about normal temperature, are said to be a third solvent, following water and organic solvents. Ionic liquids have a vapor pressure of almost zero, and have flame retardancy, low viscosity, and high electrical conductivity in combination. Ionic liquids are being applied to fields of chemical reactions and separation, heat transfer media, battery internal liquids, and other applications, and are expected to be applied to a wide range of fields, including environmentally friendly solvents, energy devices such as batteries, and other applications. As methods for producing ionic liquids, an ion exchange method, a neutralization method, and a method using an acid ester or acid-base neutralization mediation are known (Non Patent Literature 1). For example, ionic liquids of Non Patent Literature 2 and others are known.

Patent Literature 1 discloses a method for producing an ionic liquid, comprising a reaction step of reacting an acid halide having an acyl group containing a functional group R1, which is any of a linear chain, a branched chain, or an aromatic ring optionally having a substituent, having 2 or more carbon atoms, an amine to which a plurality of alkyl groups having 2 or more and 8 or less carbon atoms and optionally having a branched chain are bonded (provided that the amine is triisoamylamine when R1 is an aromatic ring), and a perfluoroalkylsulfonimide compound having a fluoroalkyl group having 3 or less carbon atoms together in an organic solvent, and a recovery step of removing the organic solvent and adding water to recover the liberated oily material.

Patent Literature 2 discloses a method for producing an ionic liquid characterized by going through a reaction between a compound composed of a cation component with imidazole as the main backbone and a halogen anion component, and an aqueous hexafluorophosphoric acid solution or aqueous tetrafluoroboric acid solution.

Patent Literature 3 discloses a method for producing an ionic liquid characterized by having a step of causing a sol-gel reaction of a quaternary ammonium salt-containing organic trialkoxysilane using an aqueous trifluoromethanesulfonimide solution as a catalyst to obtain an ionic liquid with a specific structure.

Patent Literature 4 discloses a method for producing a hydrophilic ionic liquid characterized by having an addition reaction step of addition of an alkylene oxide to an amine in an aqueous solvent to obtain an onium ion of a quaternized amine having a hydroxide ion as a counter anion, a neutralization step of neutralizing the reaction solution after the addition reaction step with an acid, and a removal step of removing water produced as a by-product after the neutralization step and the aqueous solvent.

### CITATION LIST

### Patent Literature

Patent Literature 1: Japanese Patent Laid-Open No. 2021-143145
Patent Literature 2: Japanese Patent Laid-Open No. 2010-111599
Patent Literature 3: Japanese Patent Laid-Open No. 2014-221737
Patent Literature 4: Japanese Patent Laid-Open No. 2015-193574

### Non Patent Literature

Non Patent Literature 1: “Ionic liquids synthesis and applications: An overview”, S. K. Singh, A. W. Savoy/Journal of Molecular Liquids 297 (2020) 112038
Non Patent Literature 2: Enabling Technologies Ionic Liquids, Chem Files Vol. 5 No. 6, Sigma-Aldrich Japan K.K., [retrieved on Oct. 23, 2021] (URL: https://www.sigmaaldrich.com/deepweb/assets/sigmaaldrich/marketing/global/documents/237/072/j_cf05-06.pdf)

### SUMMARY OF INVENTION

### Technical Problem

The properties of ionic liquids vary depending on the combination of positive ions and negative ions, and a myriad of combinations exist. Currently, however, the synthesis of an ionic liquid (C⁺A⁻) requires preparation and reaction of two raw material substances having a negative ion (such as OH⁻ or Cl⁻) or a positive ion (such as H³⁰ or Ag⁺) as the counter ion (for example, C⁺Cl⁻ and Ag⁺A⁻) that produce water or a precipitate. Conventional methods, Patent Literatures 1 to 4, and others have been proposed, but in order to obtain high purity products, the generated by-products (such as AgCl and H₂O) must be removed. In addition, since ionic liquids with various physical properties can be obtained depending on the combination, new production methods are also required.

Under such circumstances, the present invention provides a production method and a production device for ionic liquids or ionic liquid raw materials of various combinations by removing and introducing ions utilizing an electric field and membrane permeation.

### Solution to Problem

As a result of diligent researches in order to solve the above problems, the present inventors have found that the following inventions meet the above object, and have reached the present invention. That is, the present invention pertains to the following inventions.

<A1> A method for producing an ionic liquid or an ionic liquid raw material, using a reactor having: a first space that is in contact with an anodic electrode part and a first ion exchange membrane part and that accommodates a first liquid; a second space that is in contact with the first ion exchange membrane part and a second ion exchange membrane part and that accommodates a second liquid; and a third space that is in contact with the second ion exchange membrane part and a cathodic electrode part and that accommodates a third liquid, the first space, the second space, and the third space being stacked in the order presented.

<B1> A method using the reactor according to <A1>,
wherein membranes of the first ion exchange membrane part and the second ion exchange membrane part are both a negative ion exchange membrane; the first liquid in the first space is a water-containing liquid for recovery; the second liquid in the second space is a cationic source; and the third liquid in the third space is an anionic source or a water-containing liquid for supply; and wherein anions (negative ions) of the cationic source are transferred to the first space via the first ion exchange membrane part, and anions (negative ions) of the anionic source or hydroxide ions of the liquid for supply are transferred to the second space via the second ion exchange membrane part, thereby producing, in the second space, the ionic liquid containing cations (positive ions) of the cationic source and anions (negative ions) of the anionic source as constituent ions, or the ionic liquid raw material containing cations (positive ions) of the cationic source and hydroxide ions of the liquid for supply as constituent ions.

<B2> A method using the reactor according to <A1>,
wherein membranes of the first ion exchange membrane part and the second ion exchange membrane part are both a positive ion exchange membrane; the first liquid in the first space is a cationic source or a water-containing liquid for supply; the second liquid in the second space is an anionic source; and the third liquid in the third space is a water-containing liquid for recovery; and wherein cations (positive ions) of the cationic source or hydrogen ions of the liquid for supply are transferred to the second space via the first ion exchange membrane part, and cations (positive ions) of the anionic source are transferred to the third space via the second ion exchange membrane part, thereby producing, in the second space, the ionic liquid containing cations (positive ions) of the cationic source and anions (negative ions) of the anionic source as constituent ions, or the ionic liquid raw material containing the hydrogen ions of the liquid for supply and anions (negative ions) of the anionic source as constituent ions.

<C1> The method wherein the reactor has: in the first space, a supply line that supplies the first liquid and a recovery line that recovers a post-reaction liquid in the first space; in the second space, a supply line that supplies the second liquid and a recovery line that recovers a post-reaction liquid in the second space; and in the third space, a supply line that supplies the third liquid and a recovery line that recovers a post-reaction liquid in the third space, and the ionic liquid or the ionic liquid raw material is produced continuously, using the reactor.

<C2> The method wherein constitution of the ionic liquid or the ionic liquid raw material is changed by switching a liquid supplied with the supply lines, using a switching means for switching.

<C3> The method wherein the liquid for recovery is pure water.

<C4> The method wherein the cationic source is a liquid containing any cation selected from the group consisting of 2HEA (2-hydroxyethylammonium)⁺ ion, BMIM (1-butyl-3-methylimidazolium)⁺ ion, and BMPyr (1-butyl-1-methylpyrrolidinium)⁺ ion.

<C5> The method wherein the anionic source is a liquid containing any anion selected from the group consisting of NO₃⁻ ion, HCOO⁻ ion, CH₃COO⁻ ion, BF₄⁻ ion, and PF₆⁻ ion.

<D1> A method for producing an ionic liquid, comprising a step of reacting the ionic liquid raw material produced by the above method with an acid or exchanging the hydroxide ions with anions of the anionic source to obtain the ionic liquid.

<D2> A method for producing an ionic liquid, comprising a step of reacting the ionic liquid raw material produced by the above method with an alkali or exchanging the hydrogen ions with cations of the cationic source to obtain the ionic liquid.

<E1> A device for producing an ionic liquid or an ionic liquid raw material, comprising a reactor having: a first space that is in contact with an anodic electrode part and a first ion exchange membrane part and that accommodates a first liquid; a second space that is in contact with the first ion exchange membrane part and a second ion exchange membrane part and that accommodates a second liquid; and a third space that is in contact with the second ion exchange membrane part and a cathodic electrode part and that accommodates a third liquid, the first space, the second space, and the third space being stacked in the order presented, wherein the ion exchange membrane parts both use a positive ion exchange membrane or a negative ion exchange membrane.

<E2> The device wherein the reactor has: in the first space, a supply line that supplies the first liquid and a recovery line that recovers a post-reaction liquid in the first space; in the second space, a supply line that supplies the second liquid and a recovery line that recovers a post-reaction liquid in the second space; and in the third space, a supply line that supplies the third liquid and a recovery line that recovers a post-reaction liquid in the third space, and the ionic liquid or the ionic liquid raw material is produced continuously, using the reactor.

### Advantageous Effect of Invention

According to the methods or devices of the present invention, ionic liquids or ionic liquid raw materials of various combinations can be produced by removing and introducing ions utilizing an electric field and membrane permeation.

### BRIEF DESCRIPTION OF DRAWINGS

FIG. 1 is a schematic diagram pertaining to a production device of the present invention.

FIG. 2 is a schematic diagram to describe the principle of the present invention.

FIG. 3 is a schematic diagram pertaining to the first production method of the present invention.

FIG. 4 is another schematic diagram pertaining to the first production method of the present invention.

FIG. 5 is a schematic diagram pertaining to the second production method of the present invention.

FIG. 6 is another schematic diagram pertaining to the second production method of the present invention.

FIG. 7 is an image pertaining to a production example of a reactor in the production device of the present invention.

FIG. 8 is a graph pertaining to Examples.

FIG. 9 is a graph pertaining to Examples.

FIG. 10 is a graph pertaining to Examples.

FIG. 11 is a graph pertaining to Examples.

FIG. 12 is a graph pertaining to Examples.

FIG. 13 is a graph pertaining to Examples.

FIG. 14 is a graph pertaining to Examples.

### DESCRIPTION OF EMBODIMENTS

Hereinafter, embodiments of the present invention will be described in detail. However, the description of the configuration requirements described below is merely an example (representative example) of the implementation of the present invention, and the present invention is not limited to what follows as long as the gist of the invention is not changed. Note that, in the case where the expression “to” is used herein, it is used as an expression including the numerical values before and after it.

### [Reactor Used in the Present Invention]

In the production method of the present invention and the production device of the present invention, a reactor is used that has: a first space that is in contact with an anodic electrode part and a first ion exchange membrane part and that accommodates a first liquid; a second space that is in contact with the first ion exchange membrane part and a second ion exchange membrane part and that accommodates a second liquid; and a third space that is in contact with the second ion exchange membrane part and a cathodic electrode part and that accommodates a third liquid, the first space, the second space, and the third space being stacked in the order presented. This reactor may hereinafter be referred to as “reactor used in the present invention”.

### [First Production Method of the Present Invention]

The first production method of the present invention is a method for producing an ionic liquid or an ionic liquid raw material, using the reactor used in the present invention, in which membranes of the first ion exchange membrane part and the second ion exchange membrane part are both a negative ion exchange membrane. The first liquid in the first space is a water-containing liquid for recovery. The second liquid in the second space is a cationic source. The third liquid in the third space is an anionic source or a water-containing liquid for supply. Then, negative ions of the cationic source are transferred to the first space via the first ion exchange membrane part. Also, negative ions of the anionic source or hydroxide ions of the liquid for supply are transferred to the second space via the second negative ion exchange membrane part, thereby producing, in the second space, the ionic liquid containing positive ions of the cationic source and negative ions of the anionic source as constituent ions, or the ionic liquid raw material containing positive ions of the cationic source and the hydroxide ions of the liquid for supply as constituent ions.

### [Second Production Method of the Present Invention]

The second production method of the present invention is a method for producing an ionic liquid or an ionic liquid raw material, using the reactor used in the present invention, in which membranes of the first ion exchange membrane part and the second ion exchange membrane part are both a positive ion exchange membrane. The first liquid in the first space is a cationic source or a water-containing liquid for supply. The second liquid in the second space is an anionic source. The third liquid in the third space is a water-containing liquid for recovery. Then, positive ions of the cationic source or hydrogen ions of the liquid for supply are transferred to the second space via the first ion exchange membrane part. Also, positive ions of the anionic source are transferred to the third space via the second negative ion exchange membrane part, thereby producing, in the second space, the ionic liquid containing positive ions of the cationic source and negative ions of the anionic source as constituent ions, or the ionic liquid raw material containing the hydrogen ions of the liquid for supply and negative ions of the anionic source as constituent ions.

### [Production Device of the Present Invention]

The production device of the present invention is a device for producing an ionic liquid or an ionic liquid raw material, comprising the reactor used in the present invention having: a first space that is in contact with an anodic electrode part and a first ion exchange membrane part and that accommodates a first liquid; a second space that is in contact with the first ion exchange membrane part and a second ion exchange membrane part and that accommodates a second liquid; and a third space that is in contact with the second ion exchange membrane part and a cathodic electrode part and that accommodates a third liquid, the first space, the second space, and the third space being stacked in the order presented, in which the ion exchange membrane parts both use a positive ion exchange membrane or a negative ion exchange membrane.

Furthermore, the production device of the present invention can be the device in which the reactor has: in the first space, a supply line that supplies the first liquid and a recovery line that recovers a post-reaction liquid in the first space; in the second space, a supply line that supplies the second liquid and a recovery line that recovers a post-reaction liquid in the second space; and in the third space, a supply line that supplies the third liquid and a recovery line that recovers a post-reaction liquid in the third space, and the ionic liquid or the ionic liquid raw material is produced continuously, using the reactor used in the present invention.

Note that the first production method of the present invention and the second production method of the present invention can be performed with the production device of the present invention. In the present application, the respective corresponding configurations can be mutually utilized.

The present invention provides a method for synthesizing ionic liquids or ionic liquid raw materials of various combinations by removing and introducing ions utilizing an electric field and membrane permeation. The present invention can also supply ionic liquids or ionic liquid raw materials to which distillation, a conventional solvent purification method, cannot be applied due to low volatility, with high purity.

The present inventors have so far devised a dissolved ion extraction device that utilizes an electric field and membrane permeation, and have made developments in sample pretreatment for dissolved ion analysis, separation by oxidation number, separation, purification and drug synthesis of radioisotope metals, and in-line concentration of minor components in ultrapure water. The dissolved ion extraction device is an in-line device that takes out and introduces ions in the solution stream, with no contamination from the surrounding environment.

In the present invention, synthesis of ionic liquids with high purity is achieved by ion replacement, in which negative ions contained in the raw material solution flowing at a constant flow rate are removed by an electric field and membrane permeation, while at the same time introducing the target negative ions (see, for example, FIG. 2).

The principle of the present invention also allows for synthesis by replacement of positive ions or negative ions, as well as simultaneous introduction of positive ions and negative ions. It is also possible to construct a synthesis system in which a selection valve is incorporated in the liquid delivery system that introduces the solution into the device, and the combination of positive ions and negative ions can be freely controlled by a computer.

Furthermore, mixed ionic liquids with several types of different negative ions for one type of positive ion, which have been studied in recent years, can also be synthesized in arbitrary proportions by controlling the amount of introduction with the electric current value. As will be disclosed in the Examples, etc., described later, the purity of ionic liquids obtained in the present invention can even achieve 98% or more.

In the case where impurities are volatile acids of Cl⁻ or F⁻, for example, these impurities can be removed at the same time by evaporating water, thereby further improving the purity. The present invention, which synthesizes ionic liquids by efficiently replacing ions in the solution stream, is also useful as a method for supplying ionic liquids with high purity.

Conventionally, production of ionic liquids has been performed by mixing acids and bases or halide salts and silver salts of the constituent ions to produce and remove the ionic liquids and removable water or silver halide precipitates produced between counter ions in the raw material substances. In such approaches, raw material substances must be prepared; however, for example, substances of the OH⁻ form of amine compounds used as positive ions are often unstable.

It is also known that it is difficult to completely remove produced silver halide precipitates from ionic liquids with high hydrophilicity. Meanwhile, there is another method in which a raw material substance that is not originally a positive ion is quaternized to form a positive ion and at the same time combined with a negative ion, but in this case as well, removal of by-products and unreacted materials and purification are problems.

In the present invention, the target ionic liquid is synthesized by replacement of ions by an electric field and membrane permeation. In this method, by-products can be suppressed since negative ions of a raw material substance are removed and the target negative ions are introduced at the same time. Therefore, purification can be performed quite easily, and for example, purification can be performed by simply removing water. Also, the present invention can be utilized to have the following advantages.

1) The source of the target positive ion can be a substance with high purity that is combined with a stable negative ion. The choice of raw material substances is expanded.

2) By using inexpensive salts as the source of positive ions and negative ions, ionic liquids, which are expensive due to stability and advanced purification, can be supplied on-demand with high purity. In particular, chloride salts are readily available, and chloride ions present in a minor amount can be removed as hydrogen chloride by removing water after synthesis, thereby allowing for further improvement in purity.

3) Unstable ionic liquids, which are necessary to acquire knowledge for estimating the chemical and physical properties of ionic liquids, can also be prepared on-demand in an amount required.

### [Production Device of the Present Invention]

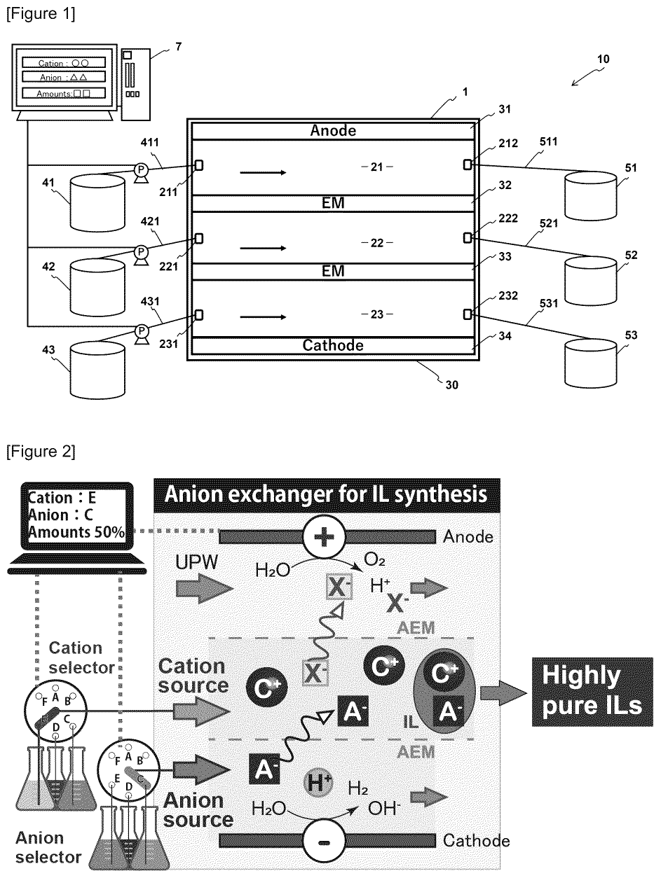

FIG. 1 is a schematic diagram pertaining to a production device of the present invention. A production device 10 has a reactor 1. In the reactor 1, a first space 21, a second space 22, and a third space 23 are stacked in the order presented. The first space 21 has an anodic electrode part 31 and a first ion exchange membrane part 32 on part of the surface that marks out the first space 21, and accommodates a first liquid. The second space 22 has the first ion exchange membrane part 32 and a second ion exchange membrane part 33 on part of the surface that marks out the second space 22, and accommodates a second liquid. The third space 23 has the second ion exchange membrane part 33 and a cathodic electrode part 34 on part of the surface that marks out the third space 23, and accommodates a third liquid. The production device 10 also has supply lines 411 to 431 and recovery lines 511 to 531.

### [Overview of the Principle Pertaining to the Present Invention]

FIG. 2 is a schematic diagram to describe the principle of the present invention. In FIG. 2, ionic liquids are produced using a negative ion exchange membrane (AEM). In production of ionic liquids, two negative ion exchange membranes are placed between an anodic electrode (anode) and a cathodic electrode (cathode) that are placed in a container. The three compartments configured by this are each supplied with a different liquid. Between the anodic electrode and the negative ion exchange membrane, ultrapure water (UPW) is placed. Between the two negative ion exchange membranes, a cationic source (cation source) is placed. Between the negative ion exchange membrane and the cathodic electrode, an anionic source (anion source) is placed. At the middle layer between the negative ion exchange membranes, ionic liquids with high purity (highly pure ILs) are produced. The cationic source can be supplied as selected by a cation selection part (cation selector), and the anionic source can be supplied as selected by an anion selection part (anion selector).

### [First Production Method of the Present Invention]

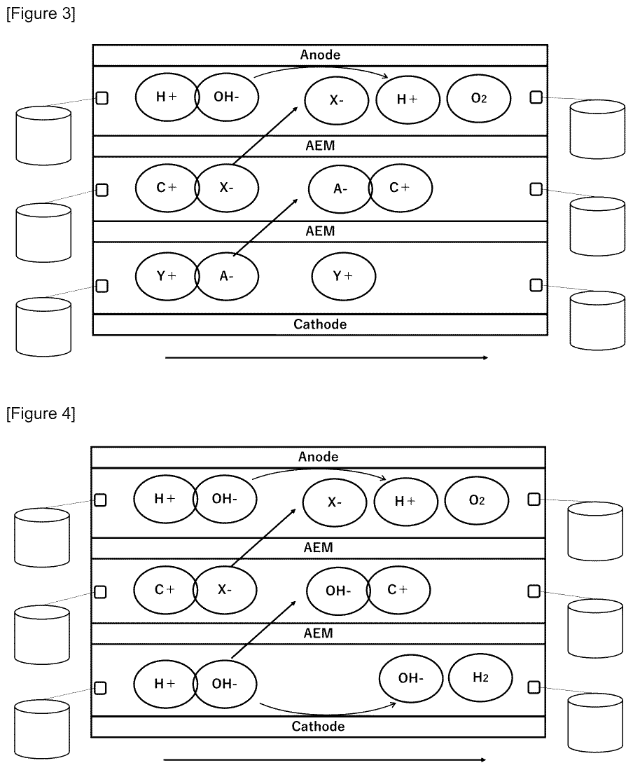

FIG. 3 is a schematic diagram pertaining to the first production method of the present invention. In this schematic diagram, each configuration conforms to the production device 10 shown in FIG. 1. In this production, the main configurations are as follows.
Ion exchange membrane: negative ion exchange membrane (AEM)
First liquid: water-containing liquid for recovery (H⁺, OH⁻)
Second liquid: cationic source (C⁺, X⁻)
Third liquid: anionic source (Y⁺, A⁻)

In this embodiment, negative ions (X⁻) of the cationic source are transferred to the first space via the first ion exchange membrane part, which is a negative ion exchange membrane. Also, negative ions (A⁻) of the anionic source are transferred to the second space via the second ion exchange membrane part, which is a negative ion exchange membrane. As a result of this, the second space is in a state where positive ions (C⁺) of the cationic source and negative ions (A⁻) of the anionic source are present. Then, by recovering what is left after the transfer, an ionic liquid (C⁺A⁻) can be produced. Note that, considering the ease of transfer via the ion exchange membrane from each raw material liquid, this first production method, in which both are a negative ion exchange membrane, may be preferable compared to the second production method described later.

FIG. 4 is a schematic diagram of another embodiment pertaining to the first production method of the present invention. In this schematic diagram, each configuration conforms to the production device 10 shown in FIG. 1. In this production, the main configurations are as follows.
Ion exchange membrane: negative ion exchange membrane (AEM)
First liquid: water-containing liquid for recovery (H⁺, OH⁻)
Second liquid: cationic source (C⁺, X⁻)
Third liquid: water-containing liquid for supply (H⁺, OH⁻)

In this embodiment, negative ions (X⁻) of the cationic source are transferred to the first space via the first ion exchange membrane part, which is a negative ion exchange membrane. Also, hydroxide ions (OH⁻) of water are transferred to the second space via the second ion exchange membrane part, which is a negative ion exchange membrane. As a result of this, the second space is in a state where positive ions (C′) of the cationic source and the hydroxide ions (OH⁻) are present. Then, by recovering what is left after the transfer, an ionic liquid raw material (C⁺OH⁻) can be produced.

### [Second Production Method of the Present Invention]

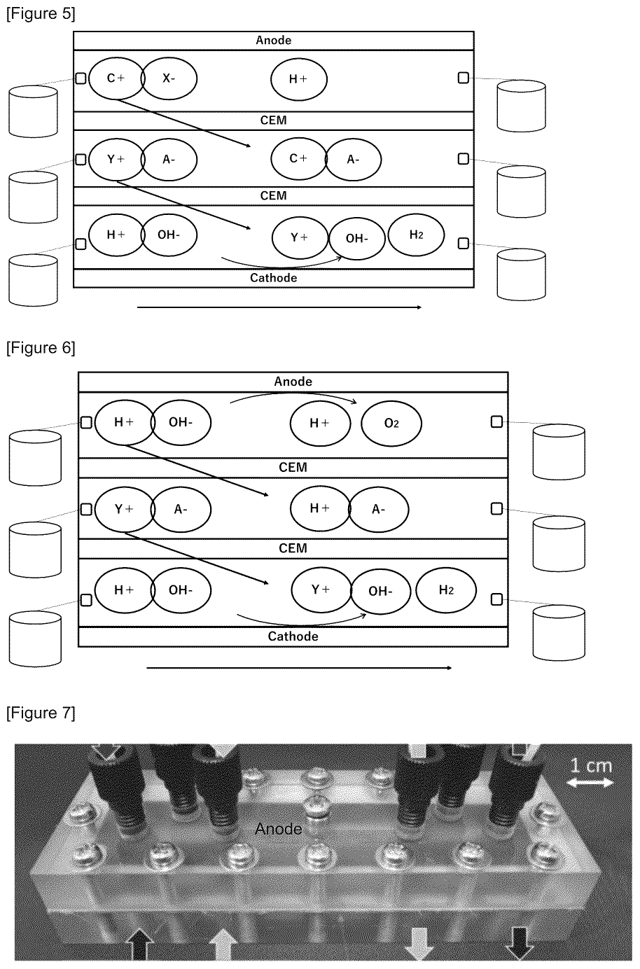

FIG. 5 is a schematic diagram pertaining to the second production method of the present invention. In this schematic diagram, each configuration conforms to the production device 10 shown in FIG. 1. In this production, the main configurations are as follows.
Ion exchange membrane: positive ion exchange membrane (CEM)
First liquid: cationic source (C⁺, X⁻)
Second liquid: anionic source (Y⁺, A⁻)
Third liquid: water-containing liquid for recovery (H⁺, OH⁻)

In this embodiment, positive ions (C′) of the cationic source are transferred to the second space via the first ion exchange membrane part, which is a positive ion exchange membrane. Positive ions (Y⁺) of the anionic source are transferred to the third space via the second negative ion exchange membrane part, which is a positive ion exchange membrane. As a result of this, the second space is in a state where positive ions (C⁺) of the cationic source and negative ions (A⁻) of the anionic source are present. Then, by recovering what is left after the transfer, an ionic liquid (C⁺A⁻) is produced.

### [Second Production Method of the Present Invention]

FIG. 6 is a schematic diagram pertaining to the second production method of the present invention. In this schematic diagram, each configuration conforms to the production device 10 shown in FIG. 1. In this production, the main configurations are as follows.
Ion exchange membrane: positive ion exchange membrane (CEM)
First liquid: water-containing liquid for supply (H⁺, OH⁻)
Second liquid: anionic source (Y⁺, A⁻)
Third liquid: water-containing liquid for recovery (H⁺, OH⁻)

In this embodiment, hydrogen ions (H⁺) of the liquid for supply are transferred to the second space via the first ion exchange membrane part, which is a positive ion exchange membrane. Positive ions (Y⁺) of the anionic source are transferred to the third space via the second negative ion exchange membrane part, which is a positive ion exchange membrane. As a result of this, the second space is in a state where the hydrogen ions (H⁺) and negative ions (A⁻) of the anionic source are present. Then, by recovering what is left after the transfer, an ionic liquid raw material (H⁺ A⁻) is produced.

### [Reactor 1]

The reactor 1 is the place where ions are transferred in producing ionic liquids using a cationic source, an anionic source, a liquid for recovery, and a liquid for supply as raw materials. This reactor accommodates each of the liquids and allows them to flow as appropriate. The reactor 1 has layers in which the first space 21, the second space 22, and the third space 23 are stacked in the order presented. The reactor 1 may also have other spaces, such as those for further allowing other liquids, gases, etc. to flow, or for protecting each layer.

### [First Space 21]

The first space 21 is in contact with an anodic electrode part 31 and a first ion exchange membrane part 32, and accommodates a first liquid. The first liquid is a liquid accommodated in the first space 21. The first liquid accommodates a water-containing liquid for recovery (H⁺, OH⁻) when using a negative ion exchange membrane, which is the first embodiment (FIG. 3). Also, when using a positive ion exchange membrane, it accommodates a cationic source (C⁺, X⁻) in the second embodiment (FIG. 5), or a water-containing liquid for supply (H⁺, OH⁻) in the second embodiment (FIG. 6).

### [Second Space 22]

The second space 22 is in contact with the first ion exchange membrane part 32 and a second ion exchange membrane part 33, and accommodates a second liquid. The second liquid is a liquid accommodated in the second space 22. The second liquid accommodates a cationic source (C⁺, X⁻) when using a negative ion exchange membrane, which is the first embodiment (FIG. 3). Also, when using a positive ion exchange membrane, which is the second embodiment (FIG. 5), it accommodates an anionic source (Y⁺, A⁻).

### [Third Space 23]

The third space 23 is in contact with the second ion exchange membrane part 33 and a cathodic electrode part 34, and accommodates a third liquid. The third liquid is a liquid accommodated in the third space 23. When using a negative ion exchange membrane, the third liquid accommodates an anionic source (Y⁺, A⁻) in the first embodiment (FIG. 3), or a water-containing liquid for supply (H⁺, OH⁻) in another example of the first embodiment (FIG. 4). Also, it accommodates a water-containing liquid for recovery (H⁺, OH⁻) when using a positive ion exchange membrane, which is the second embodiment (FIG. 5).

The first space 21 to the third space 23 are marked out by a container 30, the anodic electrode part 31, the first ion exchange membrane part 32, the second ion exchange membrane part 33, and the cathodic electrode part 34. An electric field is generated by passing an electric current between the anodic electrode part 31 and the cathodic electrode part 34, and ions are transferred from the liquid accommodated in each space via the ion exchange membrane. Then, an ionic liquid or an ionic liquid raw material is made in the second space 22, and recovered.

The capacity, etc. of each space is not particularly limited, as long as a liquid amount suited for this purpose can be accommodated and each ion can be sufficiently transferred. If each space is too thick, it may be difficult to apply a sufficient electric field, or it may be necessary to increase the voltage, etc. for generating an electric field. In addition, it may be difficult to adjust the purity of the ionic liquid due to the difference in the degree of ion transfer depending on the distance from the ion exchange membrane.

For this reason, the thickness of each space can be set as appropriate depending on the transfer time and other factors based on the combination of cationic source, anionic source, ion exchange membrane, etc. For the thickness of each space, thinner is more suited due to the shorter transfer distance and lower voltage for the required electric current. The thickness can be, for example, 10 mm or less, 5 mm or less, or 2 mm or less. Note that the thickness here is, in the first space 21, the distance between the anodic electrode part 31 and the first ion exchange membrane part 32. In the second space 22, the thickness is the distance between the first ion exchange membrane part 32 and the second ion exchange membrane part 33. In the third space 23, the thickness is the distance between the second ion exchange membrane part 33 and the cathodic electrode part 34.

### [Anodic Electrode Part 31]

The anodic electrode part 31 is the part that functions as an anodic electrode. The anodic electrode part 31 may be a metal member or the like that is an anodic electrode itself pasted onto the inner surface of the container 30, or may be provided with a protective member that maintains the function as an anodic electrode, as appropriate, in consideration of reactivity, etc. with the first liquid with which the anodic electrode part 31 is in contact.

### [Cathodic Electrode Part 34]

The cathodic electrode part 34 is the part that functions as a cathodic electrode. The cathodic electrode part 34 may be a metal member or the like that is a cathodic electrode itself pasted onto the inner surface of the container 30, or may be provided with a protective member that maintains the function as a cathodic electrode, as appropriate, in consideration of reactivity, etc. with the third liquid with which the cathodic electrode part 34 is in contact.

As the anodic electrode part 31 and the cathodic electrode part 34, those connected to an electric wire or power source are used so that an electric field is generated between the electrodes. The anodic electrode part 31 and cathodic electrode part 34, for example, can be connected to an electric wire and a power source by pasting electrode members on their respective opposing sides of the square container 30. The amount of ion replacement can be controlled, for example, by electric current. The voltage needed to apply a constant electric current is determined by the ease of ion transfer and the thickness of each space. The electric current value can be set as appropriate, in consideration of the flow rate of each solution, production amount, reaction time, ion concentration, and other factors. The reactor 1 is preferably thin, as described above in part. Also, the electric current can be about 5 mA to 10 A, 10 mA to 1 A, or 20 mA to 0.5 A.

### [Ion Exchange Membrane Parts 32 and 33]

The ion exchange membrane parts 32 and 33 are the parts where membranes are placed for ion exchange between the cationic source, the anionic source, and the liquid for recovery, placed in each space. For the ion exchange membrane parts 32 and 33, those with the same polarity are used, such that both use a positive ion exchange membrane, or both use a negative ion exchange membrane. As a result of this, ions are replaced between them, producing an ionic liquid. The ion exchange membrane in the ion exchange membrane parts preferably has a moderate exchange capacity and high ion permeability. For the ion exchange membrane parts 32 and 33, the same ion exchange membrane may be used for both, or different ones may be used depending on the type and size of ions to be transferred via the respective ion exchange membranes.

### [Positive Ion Exchange Membrane]

The positive ion exchange membrane is a membrane that selectively allows positive ions to permeate. The positive ion exchange membrane can be one that allows positive ions to permeate where there is an electric field. The positive ion exchange membrane is selected for use in consideration of resistance to the liquid accommodated in each space, permeability, etc. The positive ion exchange membrane used is one in which a negatively charged group such as sulfo group or carboxyl group is introduced into a base material composed of styrene-divinylbenzene or polytetrafluoroethylene such as Teflon (R), etc. For example, CMVN, CMTE, HSF, CMF, etc., of AGC Engineering Selemion (R) can be used (see URL: https://www.agec.co.jp/agec/pdf/selemion.pdf). It is also preferable to use a thin one, such as one with a thickness of 120 μm or less, such that ions can easily permeate.

### [Negative Ion Exchange Membrane]

The negative ion exchange membrane is a membrane that selectively allows negative ions to permeate. The negative ion exchange membrane can be one that allows negative ions to permeate where there is an electric field. The negative ion exchange membrane is selected for use in consideration of resistance to the liquid accommodated in each space, permeability, etc. The negative ion exchange membrane used is one in which a positively charged group such as amino group, trimethylamino group, or vinylpyridine group is introduced into a base material composed of styrene-divinylbenzene, etc. For example, DSVN, AMVN, AAV, ASVN, AHO, etc., of AGC Engineering Selemion (R) can be used. It is also preferable to use a thin one, such as one with a thickness of 120 μm or less, such that ions can easily permeate.

### [Container 30]

The container 30 is one to which each part of the reactor 1 is attached and which partially constitutes each space. The container 30 may be any container as long as it accommodates the liquid, does not leak, has resistance to the liquid, and is not prone to unintended reactions with the liquid. The container 30 preferably has high insulation properties to facilitate control of the electric current and other factors between the anodic electrode part 31 and the cathodic electrode part 34. For example, those made of resins or ceramics can be used. Polypropylene, polystyrene, and others can be used as the resins.

[Liquid for Recovery] (H⁺, OH⁻)

The liquid for recovery is a liquid for recovering unneeded ions as a result of ion exchange in the reactor 1. The liquid for recovery is the liquid that is accommodated in the first space 21 or the third space 23, depending on the embodiment. The liquid for recovery may be any liquid as long as it contains water, and ions are recovered in this water. The liquid for recovery is preferably pure water, which prevents other reactions and ion exchange, or the like, and is easy to handle. Note that the liquid for recovery contains water (H₂O) and may be described in the figure by H⁺ and OH⁻ as ions that contribute to electrolysis, ion exchange, etc.

[Cationic Source] (C⁺, X⁻)

The cationic source is the supply source that supplies cations of an ionic liquid. The cationic source is also a liquid. In the case where the cationic source alone has flowability, it may be used as a pure substance, or it may be used as an aqueous solution, as appropriate. Note that, as for the cationic source, the cations in the ionic liquid may be described as “C⁺” and the anionic substances, such as chloride ions and hydroxide ions, as raw materials in the cationic source may be described as “X⁻”.

Examples of the cations (C⁺) of the cationic source include cations such as imidazolium salts, pyrrolidinium salts, pyridinium salts, piperidinium salts, ammonium salts, and phosphonium salts. The cationic source can be a liquid containing any cation selected from the group consisting of, for example, 2HEA (2-hydroxyethylammonium)⁺ ion, BMIM (1-butyl-3-methylimidazolium)⁺ ion, and BMPyr (1-butyl-1-methylpyrrolidinium)⁺ ion.

[Anionic Source] (Y⁺, A⁻)

The anionic source is the supply source that supplies anions of an ionic liquid. The anionic source is also a liquid. In the case where the source alone has flowability, it may be used as a pure substance, or it may be used as an aqueous solution, as appropriate. Note that, as for the anionic source, the anions in the ionic liquid may be described as “A⁻” and the cationic substances, such as hydrogen ions and metal ions, as raw materials in the anionic source may be described as “Y*”.

The anionic source (A⁻) can be a liquid containing any anion selected from the group consisting of, for example, Cl⁻, Br⁻, I⁻, NO₃⁻ ion, HCOO⁻ ion, CH₃COO⁻ ion, BF₄⁻ ion, and PF₆⁻ ion.

[Liquid for Supply] (H⁺, OH⁻)

The liquid for supply is a liquid for supplying hydrogen ions or hydroxide ions as a result of ion exchange in the reactor 1. The liquid for supply is the liquid that is accommodated in the first space 21 or the third space 23, depending on the embodiment. The liquid for supply may be any liquid as long as it contains water, and ions in this water are supplied. The liquid for supply is preferably pure water, which prevents other reactions and ion exchange, or the like, and is easy to handle. Note that the liquid for supply contains water (H₂O) and may be described in the figure by H⁺ and OH⁻ as ions that contribute to electrolysis, ion exchange, etc.

[Ionic Liquid] (C⁺A⁻)

The ionic liquid is a liquid composed of ions, anions and cations. The ionic liquid may contain impurities and other materials that are contained unavoidably, difficult to remove, or intentionally mixed, or it may be composed substantially solely of ionic liquid. The ionic liquid is composed of cations (C⁺) of the cationic source and anions (A⁻) of the anionic source. Examples thereof include those described in Non Patent Literature 1, Non Patent Literature 2, and Patent Literatures 1 to 4.

Specific examples thereof include the following. Examples of ionic liquids using 1-butyl-3-methylimidazolium as the cation include “1-butyl-3-methylimidazolium nitrate”, “1-butyl-3-methylimidazolium formate”, “1-butyl-3-methylimidazolium acetate”, “1-butyl-3-methylimidazolium tetrafluoroborate”, “1-butyl-3-methylimidazolium hexafluorophosphate”, and “1-butyl-3-methylimidazolium bis(trifluoromethylsulfonyl)imide”.

In addition, examples of ionic liquids using 1-hexyl-3-methylimidazolium as the cation include “1-hexyl-3-methylimidazolium chloride”, “1-hexyl-3-methylimidazolium trifluoromethanesulfonate”, “1-hexyl-3-methylimidazolium tetrafluoroborate”, and “1-hexyl-3-methylimidazolium hexafluorophosphate”.

In addition, examples of ionic liquids using 1-allyl-3-methylimidazolium as the cation include “1-allyl-3-methylimidazolium chloride”, “l-allyl-3-methylimidazolium dicyanamide”, “1-allyl-3-methylimidazolium bis(trifluoromethylsulfonyl)imide”, and “1-allyl-3-methylimidazolium iodide”.

In addition, examples of ionic liquids using 1-butyl-3-vinylimidazolium as the cation include “1-butyl-3-vinylimidazolium bis(trifluoromethylsulfonyl)imide”.

In addition, examples of ionic liquids using 2-hydroxyethylammonium as the cation include “2-hydroxyethylammonium nitrate”, “2-hydroxyethylammonium formate”, and “2-hydroxyethylammonium acetate”.

In addition, examples of ionic liquids using 1-butyl-1-methylpyrrolidinium as the cation include “1-butyl-1-methylpyrrolidinium nitrate”, “1-butyl-1-methylpyrrolidinium formate”, “1-butyl-1-methylpyrrolidinium acetate”, “1-butyl-1-methylpyrrolidinium bis(trifluoromethylsulfonyl)imide”, “1-butyl-1-methylpyrrolidinium dicyanamide”, “1-butyl-1-methylpyrrolidinium hexafluorophosphate”, and “1-butyl-1-methylpyrrolidinium triflate”.

In addition, examples of ionic liquids using 1-ethyl-1-methylpyrrolidinium as the cation include “1-ethyl-1-methylpyrrolidinium bis(trifluoromethylsulfonyl)imide”.

In addition, examples of ionic liquids using 1-butyl-1-methylpiperidinium as the cation include “1-butyl-1-methylpiperidinium bis(trifluoromethylsulfonyl)imide”, “1-butyl-1-methylpiperidinium triflate”, and “1-butyl-1-methylpiperidinium hexafluorophosphate”.

In addition, examples of ionic liquids using 1-butyl-2-methylpyridinium as the cation include “1-butyl-2-methylpyridinium bis(trifluoromethylsulfonyl)imide”, “1-butyl-2-methylpyridinium hexafluorophosphate”, “1-butyl-2-methylpyridinium tetrafluoroborate”, and “1-butyl-2-methylpyridinium triflate”.

[Ionic Liquid Raw Material] (C⁺OH⁻), (H⁺A⁻)

The ionic liquid raw material is a liquid composed of ions, cations and hydroxide ions. Alternatively, it is a liquid composed of ions, hydrogen ions and anions. The ionic liquid raw material is a raw material for obtaining an ionic liquid by replacing these hydrogen ions with cations or replacing hydroxide ions with anions. The ionic liquid raw material may contain impurities and other materials that are contained unavoidably, difficult to remove, or intentionally mixed, or it may be composed substantially solely of ionic liquid.

The ionic liquid can be obtained by reacting the ionic liquid raw material composed of ions, cations and hydroxide ions, with an acid, or by exchanging the hydroxide ions with anions of the anionic source. The ionic liquid can be obtained by reacting the ionic liquid raw material composed of ions, hydrogen ions and anions, with an alkali, or by exchanging the hydrogen ions with cations of the cationic source. These steps may be performed to produce the ionic liquid by utilizing the ionic liquid raw material as the cationic source or the anionic source in the reactor used in the present invention. The use of such an ionic liquid raw material for producing ionic liquids can also allow for efficient production of ionic liquids with high purity.

The ionic liquid or ionic liquid raw material produced in the second space may be produced as is to become an ionic liquid or ionic liquid raw material, or the solvent or other materials used in combination for flow may be removed, as appropriate.

### [Supply Line and Recovery Line]

The production device 10 can be a continuous production device, in which each space is supplied with a liquid and the liquid is recovered after performing ion exchange. In the production of the present invention, since the ion exchange situation changes over time, it is preferable to design the residence time, exchange efficiency, etc. in each space and to conduct continuous production in which fresh raw material liquids are supplied while post-reaction liquids are taken out.

In the production device 10, each space is provided with a supply line and a recovery line. The first space 21 has openings, a supply port 211 and a recovery port 212. The supply port 211 is provided with a supply line that supplies the first liquid from a container 41 that accommodates the first liquid through piping 411 by means of a pump. Also, the recovery port 212, which is connected to piping 511 and a container 51, is provided with a recovery line that recovers a post-reaction liquid in the first space through the piping 511 to the container 51.

Similarly, the second space 22 is provided with a container 42 and piping 421 on the supply port 221 side as those forming a supply line that supplies the second liquid. Also, a container 52 and piping 521 are provided on the recovery port 222 side as those forming a recovery line that recovers a post-reaction liquid in the second space. In addition, the third space 23 is provided with a container 43 and piping 431 on the supply port 231 side as those forming a supply line that supplies the third liquid. Also, a container 53 and piping 531 are provided on the recovery port 232 side as those forming a recovery line that recovers a post-reaction liquid in the third space.

This allows the respective liquids in the first space 21, the second space 22, and the third space 23 to flow from left to right in FIGS. 1 to 6. The ions are sequentially transferred through the ion exchange membrane, and the ion constitution is shifted by the time reaching the vicinity of the recovery port, resulting in an ionic liquid or ionic liquid raw material in the second space 22. In this way, using the reactor 1 of the production device 10, the ionic liquid or the ionic liquid raw material can be produced continuously.

### [Switching Part]

The amount of each liquid supplied to each space in the reactor 1 can be controlled by a controller 7. The controller 7 is input with the proportion of replacement to the ionic liquid to be produced, as well as the combination of anionic source and cationic source. This input information can be confirmed on a display part as appropriate. The controller 7 can also be input with the content of switching the liquid being produced, and based on that content, the cationic source or anionic source to which each supply line is connected can be switched. The constitution of the ionic liquid can be changed by switching a liquid supplied with the supply lines, using a switching means for switching. As a result of this, the ionic liquid to be produced can be smoothly changed, or the ionic liquid to be recovered can be made into a mixed ionic liquid, in which a plurality of ionic liquids are mixed.

The present invention can be considered to relate to an approach for supplying ionic liquids, which currently attracts attention in green chemistry and efficient energy circulation, on-demand with high purity, and is expected to be deployed in a variety of industrial fields. In addition, unlike conventional approaches, it is possible to create combinations of positive ions and negative ions with a high degree of freedom, thereby promoting researches of ionic liquids.

In the development of products using ionic liquids, it is useful to evaluate ionic liquids of various combinations and select the optimal one. The production device according to the present invention can readily realize small-lot, wide-variety production, and is therefore useful as a fundamental technology in the research and development of ionic liquids. Using the system of the present invention as an array, multiple systems can be arranged in parallel for scale-up, making it possible to construct an ionic liquid supply device that can be used from research and development to practical scale.

As described above, the present invention can be achieved as, for example, in the case of a configuration using a negative ion exchange membrane, a method, etc. in which a flow channel sandwiched between an anode and a cathode is partitioned by two negative ion exchange membranes to form a three-layer structure; ultrapure water is supplied to a flow channel in contact with the anode; a desired negative ion solution is supplied to a flow channel in contact with the cathode; a desired positive ion solution is supplied to an intermediate flow channel; and a direct current electric field is applied between the anode and the cathode so that negative ions of the positive ion solution are replaced by negative ions of the negative ion solution, thereby obtaining an ionic liquid with high purity from the intermediate flow channel. The present invention can also be one in which an ionic liquid raw material is obtained by the production method, etc. of the present invention described above, or one in which an ionic liquid or ionic liquid raw material is obtained using a positive ion exchange membrane.

### EXAMPLES

Hereinafter, the present invention will be described in further detail by means of Examples, but the present invention is not limited to the following Examples as long as the gist thereof is not changed.

FIG. 7 is an image pertaining to a production example of a reactor in the production device of the present invention. This reactor uses a container made of vinyl chloride that provides a hollow space inside that serves as a flow channel. The gasket is made of Parafilm with a channel pattern cut out therefrom, thermo-compressed to a nylon mesh. A cathodic electrode (platinum mesh) was placed on the inner bottom surface of the container, corresponding to the lower part of the image, and a platinum mesh serving as an anodic electrode was placed on the inner top surface of the container, corresponding to the upper part of the image. Between the electrodes, two negative ion exchange membranes, “Selemion (R) ‘DSVN’” manufactured by AGC Engineering, were placed. In this way, a reactor was fabricated that had the following configuration, from top to bottom, in the container.

Configuration: anodic electrode/first space/first ion exchange membrane/second space/second ion exchange membrane/third space/cathodic electrode

Supply ports that supply different liquids to the respective spaces were provided on the left side of the reactor 1, and recovery ports that recover liquids that have reacted in the reactor 1 were provided on the right side of the reactor 1. The first space is separated from the second space by the first ion exchange membrane. The second space is separated from the third space by the second ion exchange membrane. Each space serves as a flow channel when the liquid is supplied continuously.

In each space, the flow channel has a width of about 5 mm, which is from the top to the bottom, and a length of about 40 mm, which is from the left to the right, when the reactor 1 is viewed in a plan view. Also, the thickness of each space, which is from the top to the bottom when the reactor 1 is viewed in a front view, is all about 130 μm.

### [Reagent]

### [Cationic Source] (Cations for Ionic Liquid: Reagent Used)

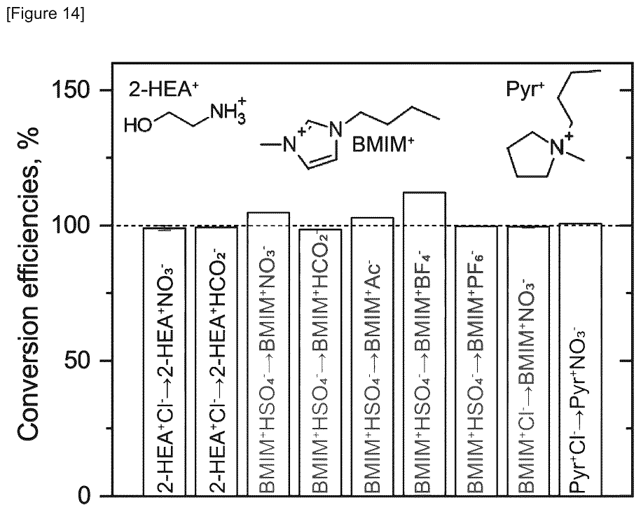

2HEA⁺ (2-hydroxyethylammonium ion) source: 2-hydroxyethylammonium salt, 2-hydroxyethylamine hydrochloride, 2-HEA⁺Cl⁻, TCI, Japan, >98%
BMIM⁺ (1-butyl-3-methylimidazolium ion) source: 1-butyl-3-methylimidazolium chloride, 1-butyl-3-methylimidazolium chloride, [BMIM]⁺Cl⁻, TCI, Japan, >98%, or 1-butyl-3-methylimidazolium tetrafluoroborate, [BMIM]⁺BF₄⁻, TCI, Japan, >98, or 1-butyl-3-methylimidazolium hydrogen sulfate, [BMIM]⁺HSO₄⁻, BLD Pharmatech Ltd., 97%
BMPyr⁺ (1-butyl-1-methylpyrrolidinium ion) source (abbreviated as “Pyr” in FIG. 14): 1-butyl-1-methylpyrrolidinium salt, 1-butyl-1-methylpyrrolidinium chloride, BMPyr⁺Cl⁻, Merck, >99%

### [Anionic Source] (Anions for Ionic Liquid: Reagent Used)

NO₃⁻ source: sodium nitrate, sodium nitrate, NaNO₃, Necalai Tesque, >99.%
HCOO⁻ source: formic acid, sodium formate, NaHCO₂, Necalai Tesque, ≥98.0%
CH₃COO⁻ source: acetic acid, sodium acetate, NaOAc, Necalai Tesque, >99.0,
BF₄⁻ source: tetrafluoroboric acid, sodium tetrafluoroborate, Na⁺BF₄⁻, Wako, 98.0%
PF₆⁻ source: hexafluorophosphoric acid, sodium hexafluorophosphate, Na⁺PF₆⁻, TCI, >98%
Ultrapure water: Ultrapure water was used as the liquid for recovery.

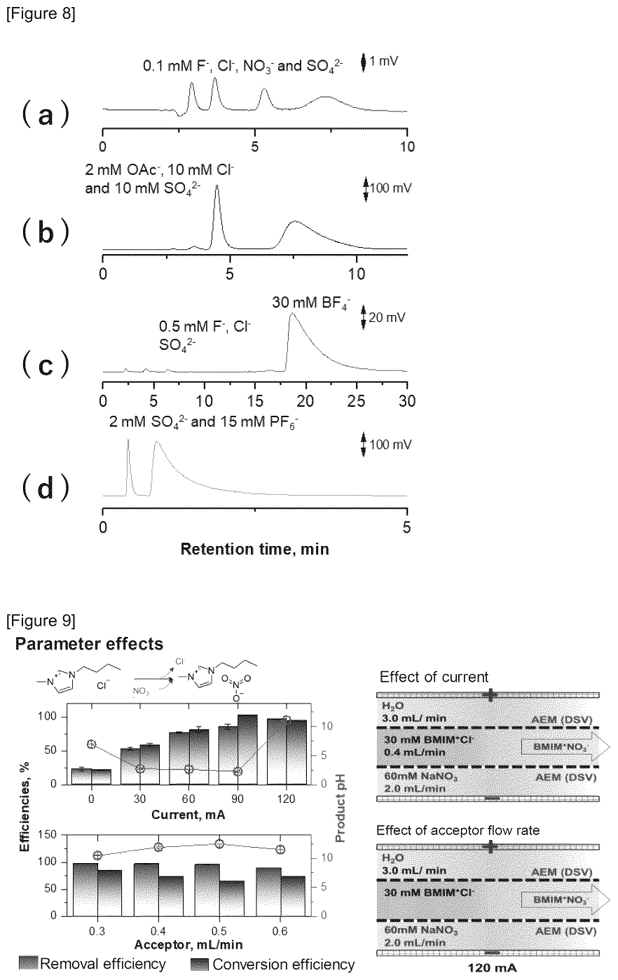

Using this reactor, various combinations of cationic sources and anionic sources were conducted to produce ionic liquids. In the following, production examples, etc., using combinations will be described using Table 1 and FIG. 8 to FIG. 14, etc.

Table 1 summarizes the physico-chemical properties of the ionic liquids (ILs) pertaining to Production Examples according to the present Examples. For each combination, the physical properties: melting point, viscosity, density, electrochemical window, and ion conductivity are summarized from the literature.

TABLE 1
Physico-chemical properties of ILs

| | | | | Electro- | |
|---|---|---|---|---|---|
| | Melting | | | chemical | Ion |
| | Point, | Viscosity | Density | window, | conductivity |
| ILs | ° C. | cP | g/cm⁻³ | V | κ/mS cm⁻¹ |
| 2-HEA⁺NO₃⁻ | 51 | 113 | 1.265 | — | 9.35 |
| 2-HEA⁺HCO₂⁻ | −82.1 | 118 | 1.204 | 1.2 | 3.291 |
| 2-HEA⁺OAc⁻ | −71 | 640 | 1.120 | — | 0.692 |
| BMIM⁺NO₃⁻ | 17.7 | 224 | 1.561 | 2.8 | 6.12 |
| BMIM⁺OAc⁻ | <−20 | 208 | 1.055 | 3.1 | 1.44 |
| BMIM⁺BF₄⁻ | −71 | 279 | 1.20 | 6.1 | 3.52 |
| BMIM⁺PF₆⁻ | −8 | 450 | 1.368 | >7.1 | — |

FIG. 8 is a graph pertaining to Examples, and shows the results of evaluating the produced ionic liquids by ion chromatography. Table 2 shows the ion chromatography column, eluent, and flow rate used for the evaluation. As for the column of Table 2, Shodex (R) is a trademark of Showa Denko K.K.

TABLE 2

| | | |
|---|---|---|
| (a) | Column | Shodex IC SI-90 4E |
| | Eluent | 1.8 mM Na₂CO₃ + |
| | | 1.7 mM NaHCO₃ |
| | Flow rate | 1.0 mL/min |
| (b) | Column | Shodex IC SI-90 4E |
| | Eluent | 1.8 mM Na₂CO₃ + |
| | | 1.7 mM NaHCO₃ |
| | Flow rate | 1.0 mL/min |
| (c) | Column | Shodex IC SI-90 4E |
| | Eluent | 10 mM NaHCO₃ |
| | Flow rate | 1.0 mL/min |
| (d) | Column | Dionex IonPac AG18 RFIC |
| | | 4 × 50 mm Guard Column |
| | Eluent | 40 mM KOH Solution |
| | Flow rate | 0.7 mL/min |

FIG. 9 is a graph pertaining to Examples, which evaluates the influence of production conditions. Here, the production was performed using BMIM⁺ as the cation and NO₃⁻ as the anion. The upper panel of FIG. 9 shows the production efficiency and pH of the produced ionic liquid when the electric current (Current) is changed. The lower panel of FIG. 9 shows the production efficiency and pH of the produced ionic liquid when the flow rate of the cationic source (Acceptor) in the second space is changed.

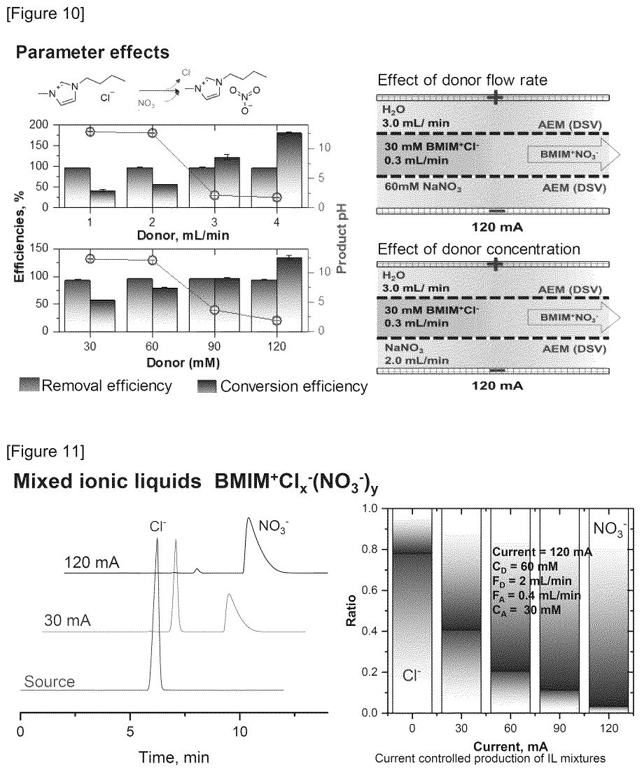

FIG. 10 is a graph pertaining to Examples, which evaluates the influence of production conditions. Here, the production was performed using BMIM⁺ as the cation and NO₃⁻ as the anion. The upper panel of FIG. 10 shows the production efficiency and pH of the produced ionic liquid when the flow rate of the anionic source (Donor) in the third space is changed. The lower panel of FIG. 10 shows the production efficiency and pH of the produced ionic liquid when the concentration of the anionic source (Donor) in the third space is changed.

FIG. 11 is a graph pertaining to Examples, and shows the constitution of mixed ionic liquids when the flow rate is changed. The production conditions here conform to those under which the study of electric current in the upper panel of FIG. 9 was conducted. By changing the electric current, the degree of replacement from Cl⁻ derived from the liquid used for the cationic source to NO₃⁻ derived from the liquid used for the anionic source can be adjusted.

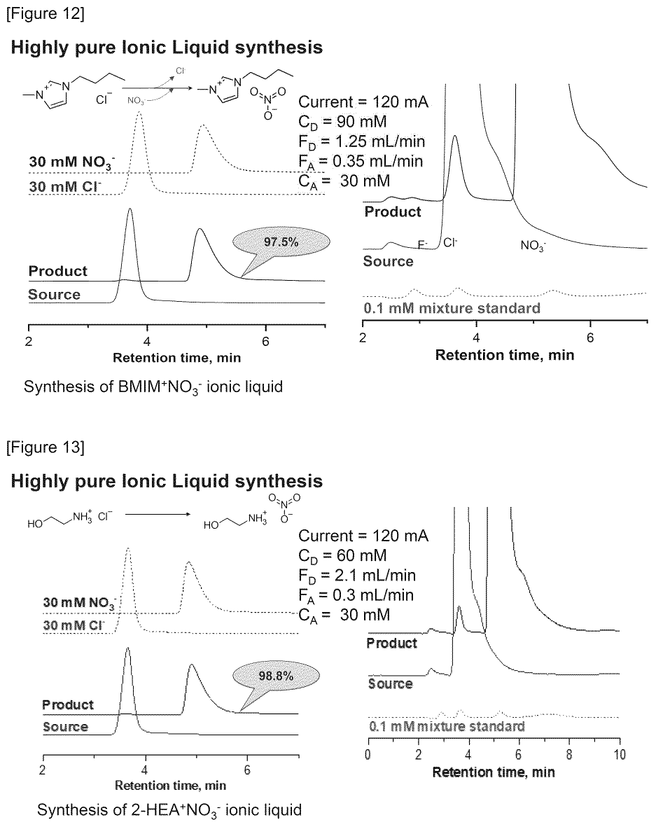

FIG. 12 is a graph pertaining to Examples, and shows the production results when highly pure ionic liquid synthesis was studied. FIG. 12 relates to Production Example of a BMIM⁺NO₃⁻ ionic liquid. By the present test, it was possible to obtain a BMIM⁺NO₃⁻ ionic liquid with a purity of 97.5%.

Also, FIG. 13 is a graph pertaining to Examples, and shows the production results when highly pure ionic liquid synthesis was studied. FIG. 13 relates to Production Example of a HEA⁺NO₃⁻ ionic liquid. By the present test, it was possible to obtain a HEA⁺NO₃⁻ ionic liquid with a purity of 98.8%.

FIG. 14 is a graph pertaining to Examples, and summarizes the conversion efficiencies of ionic liquids of various combinations. Ionic liquids of various combinations could be produced with high conversion efficiencies. Note that the evaluation results shown in these figures are the purity determined from the concentration of negative ions. If the produced ionic liquid solution contains impurities such as hydrogen ions, their counter ions may be the target anions and may be contained. Also, hydrogen ions are produced by dissociation of water as well. Therefore, when OH⁻ is removed by the negative ion exchange membrane and electric field, they may remain under certain conditions, and the conversion efficiency may exceed 100%.

### INDUSTRIAL APPLICABILITY

The present invention can be utilized for the production of ionic liquids and ionic liquid raw materials, and is industrially useful.

### REFERENCE SIGNS LIST

1 reactor
10 production device
21 first space
22 second space
23 third space
211, 221, 231 supply port
212, 222, 232 recovery port
30 container
31 anodic electrode part
32 first ion exchange membrane part
33 second ion exchange membrane part
34 cathodic electrode part
41 to 43, 51 to 54 container
411, 421, 431, 511, 521, 531 piping
7 controller

1. A method for producing an ionic liquid or an ionic liquid raw material, using a reactor having
a first space that is in contact with an anodic electrode part and a first ion exchange membrane part and that accommodates a first liquid,
a second space that is in contact with the first ion exchange membrane part and a second ion exchange membrane part and that accommodates a second liquid, and
a third space that is in contact with the second ion exchange membrane part and a cathodic electrode part and that accommodates a third liquid,
the first space, the second space, and the third space being stacked in the order presented,
wherein membranes of the first ion exchange membrane part and the second ion exchange membrane part are both a negative ion exchange membrane,
the first liquid in the first space is a water-containing liquid for recovery,
the second liquid in the second space is a cationic source, and
the third liquid in the third space is an anionic source or a water-containing liquid for supply, and
wherein anions of the cationic source are transferred to the first space via the first ion exchange membrane part, and
anions of the anionic source or hydroxide ions of the liquid for supply are transferred to the second space via the second ion exchange membrane part,
thereby producing, in the second space, the ionic liquid containing cations of the cationic source and anions of the anionic source as constituent ions, or the ionic liquid raw material containing cations of the cationic source and the hydroxide ions of the liquid for supply as constituent ions.

2. A method for producing an ionic liquid or an ionic liquid raw material, using a reactor having
a first space that is in contact with an anodic electrode part and a first ion exchange membrane part and that accommodates a first liquid,
a second space that is in contact with the first ion exchange membrane part and a second ion exchange membrane part and that accommodates a second liquid, and
a third space that is in contact with the second ion exchange membrane part and a cathodic electrode part and that accommodates a third liquid,
the first space, the second space, and the third space being stacked in the order presented,
wherein membranes of the first ion exchange membrane part and the second ion exchange membrane part are both a positive ion exchange membrane,
the first liquid in the first space is a cationic source or a water-containing liquid for supply,
the second liquid in the second space is an anionic source, and
the third liquid in the third space is a water-containing liquid for recovery, and
wherein cations of the cationic source or hydrogen ions of the liquid for supply are transferred to the second space via the first ion exchange membrane part, and
cations of the anionic source are transferred to the third space via the second ion exchange membrane part,
thereby producing, in the second space, the ionic liquid containing cations of the cationic source and anions of the anionic source as constituent ions, or the ionic liquid raw material containing the hydrogen ions of the liquid for supply and anions of the anionic source as constituent ions.

3. The method for producing an ionic liquid or an ionic liquid raw material according to claim 1, wherein the reactor has
in the first space, a supply line that supplies the first liquid and a recovery line that recovers a post-reaction liquid in the first space,
in the second space, a supply line that supplies the second liquid and a recovery line that recovers a post-reaction liquid in the second space, and
in the third space, a supply line that supplies the third liquid and a recovery line that recovers a post-reaction liquid in the third space, and
the ionic liquid or the ionic liquid raw material is produced continuously, using the reactor.

4. The method according to claim 3, wherein constitution of the ionic liquid or the ionic liquid raw material is changed by switching a liquid supplied with the supply lines, using a switching means.

5. The method according to claim 1,
wherein the liquid for recovery is pure water,
the cationic source is a liquid containing any cation selected from the group consisting of 2-hydroxyethylammonium ion, 1-butyl-3-methylimidazolium ion, 1-hexyl- and 1-butyl-1-methylpyrrolidinium ions, and
the anionic source is a liquid containing any anion selected from the group consisting of NO₃⁻ ion, HCOO⁻ ion, CH₃COO⁻ ion, BF₄⁻ ion, and PF₆⁻ ion.

6. A method for producing an ionic liquid, comprising a step of reacting the ionic liquid raw material obtained by the method according to claim 1 with an acid or exchanging the hydroxide ions with anions of the anionic source to obtain the ionic liquid.

7. A method for producing an ionic liquid, comprising a step of reacting the ionic liquid raw material obtained by the method according to claim 2 with an alkali or exchanging the hydrogen ions with cations of the cationic source to obtain the ionic liquid.

8. A device for producing an ionic liquid or an ionic liquid raw material, comprising a reactor having
a first space that is in contact with an anodic electrode part and a first ion exchange membrane part and that accommodates a first liquid,
a second space that is in contact with the first ion exchange membrane part and a second ion exchange membrane part and that accommodates a second liquid, and
a third space that is in contact with the second ion exchange membrane part and a cathodic electrode part and that accommodates a third liquid,
the first space, the second space, and the third space being stacked in the order presented,
wherein the ion exchange membrane parts both use a negative ion exchange membrane,
the first liquid in the first space is a water-containing liquid for recovery,
the second liquid in the second space is a cationic source, and
the third liquid in the third space is an anionic source or a water-containing liquid for supply, and
wherein anions of the cationic source are transferred to the first space via the first ion exchange membrane part, and
anions of the anionic source or hydroxide ions of the liquid for supply are transferred to the second space via the second ion exchange membrane part,
thereby producing, in the second space, the ionic liquid containing cations of the cationic source and anions of the anionic source as constituent ions, or the ionic liquid raw material containing cations of the cationic source and the hydroxide ions of the liquid for supply as constituent ions.

9. The device for producing an ionic liquid or an ionic liquid raw material according to claim 8, wherein the reactor has
in the first space, a supply line that supplies the first liquid and a recovery line that recovers a post-reaction liquid in the first space,
in the second space, a supply line that supplies the second liquid and a recovery line that recovers a post-reaction liquid in the second space, and
in the third space, a supply line that supplies the third liquid and a recovery line that recovers a post-reaction liquid in the third space, and
the ionic liquid or the ionic liquid raw material is produced continuously, using the reactor.

10. The device according to claim 9,
wherein at least one or more supply lines selected from the group consisting of the supply line that supplies the first liquid, the supply line that supplies the second liquid, and the supply line that supplies the third liquid have a switching part that can supply a plurality of types of liquids, and
the device has a controlling part that controls a supply amount and/or type of liquid of at least one or more liquids of the first liquid, the second liquid, and the third liquid.

11. A device for producing an ionic liquid or an ionic liquid raw material, comprising a reactor having
a first space that is in contact with an anodic electrode part and a first ion exchange membrane part and that accommodates a first liquid,
a second space that is in contact with the first ion exchange membrane part and a second ion exchange membrane part and that accommodates a second liquid, and
a third space that is in contact with the second ion exchange membrane part and a cathodic electrode part and that accommodates a third liquid,
the first space, the second space, and the third space being stacked in the order presented,
wherein the ion exchange membrane parts both use a positive ion exchange membrane,
the first liquid in the first space is a cationic source or a water-containing liquid for supply,
the second liquid in the second space is an anionic source, and
the third liquid in the third space is a water-containing liquid for recovery, and
wherein cations of the cationic source or hydrogen ions of the liquid for supply are transferred to the second space via the first ion exchange membrane part, and
cations of the anionic source are transferred to the third space via the second ion exchange membrane part,
thereby producing, in the second space, the ionic liquid containing cations of the cationic source and anions of the anionic source as constituent ions, or the ionic liquid raw material containing the hydrogen ions of the liquid for supply and anions of the anionic source as constituent ions.
